(19) United States
(12) Patent Application Publication
(10) Pub. No.: US 2007/0115822 A1
(43) Pub. Date: May 24, 2007

(54) Configuring network interface on home network

(75) Inventor: Eddy Albert Marie Odijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/571,805

(22) PCT Filed: Sep. 15, 2004
(86) PCT No.: PCT/IB04/51764

§ 371 Date: Mar. 15, 2006

(30) Foreign Application Priority Data
Sep. 23, 2003 (EP) 03103515.7

(51) Int. Cl. H04J 1/16

(52) U.S. Cl. 370/235; 340/10.1

(57) ABSTRACT

A CE data processing system is configurable to communicate via a particular one of multiple data network environments. The system comprises a receiver for receiving configuration data from a physical token for configuring the system. The system comprises an appliance for data network communication via a network interface. The appliance accommodates the receiver for receiving the configuration data for configuring the network interface. The token and the receiver communicate in a wireless fashion.

### FIELD OF THE INVENTION

The invention relates to a method for configuring network equipment especially, but not exclusively, consumer electronics (CE) and home network apparatus. The invention further relates to a configurable network device, especially but not exclusively, to a broadband modem.

### BACKGROUND ART

A network relies on the interoperability of the apparatus making up the network. A new apparatus that is to be added to the network may need to be configured so as to be able to interact with the network. Network-enabled equipment is pervading the CE market at an increasingly higher pace. As the typical end-user of CE apparatus is not an expert in configuring and customizing network equipment, some assistance is required before newly acquired equipment is ready for operational use. Typically, assistance is provided by a help-desk of, e.g., service provider or manufacturer. This, however, is a relatively expensive and time-consuming service. In addition, consumers have come to expect a minimum of hassle when it comes to use of CE equipment. Hot plug-and-play is preferred, but cannot always be attained.

An alternative to help-desk assistance to consumers in facilitating the configuration and customization of CE equipment is discussed in U.S. Ser. No. 09/519,546 (attorney docket US 000014) filed Mar. 3, 2000 for Erik Ekkel et al., for PERSONALIZING CE EQUIPMENT CONFIGURATION AT SERVER VIA WEB-ENABLED DEVICE, published as International Application WO0154406 and incorporated herein by reference. This document relates to facilitating the configuring of CE equipment by means of delegating the configuring to an application server on the Internet. The consumer enters his/her preferences in a specific interactive Web page through a suitable user-interface of an Internet-enabled device such as a PC or set-top box or digital cell phone. The application server generates the control data based on the preferences entered and downloads the control data to the CE equipment itself or to the Internet-enabled device.

Another approach is discussed in U.S. Ser. No. 10/034,664 (attorney docket US 018213) filed Dec.28, 2001 Paul Chambers for METHOD TO AUTOMATICALLY CONFIGURE NETWORK ROUTING DEVICE, published as International Application WO03056759 and incorporated herein by reference. This document relates to a home network with a data processing device and a network access device for access to an external network. When a new device is added the network is to be configured. Configuration is done as follows. The communication between the data processing device and the access device is monitored. Then, information is extracted from the communication about protocols and external network addresses. The home network can then be configured automatically based on the information extracted.

Yet another manner is described in U.S. patent application publication no. 20020004935, incorporated herein by reference. This document mentions, among other things, providing the configuration file of a DSL-modem on a disk or CD-ROM. The automated system retrieves the configuration file from the disk or CD-ROM, and then uses the configuration file to configure the subscriber's DSL modem.

### SUMMARY OF THE INVENTION

The inventor proposes an alternative to known manners to facilitate the configuring of data network equipment, especially CE equipment such as set-top boxes, Internet TVs, digital video recorders (DVRs), and other apparatus on the home network. Now consider, e.g., ADSL, cable or other broadband modems that need to be configured according to settings specific to the data network, to which the modem forms a communication interface for the end-user's CE equipment, and specific to the individual end-user. According to the invention, broadband configuration information is provided stored in a token (e.g., an RFID tag) by the broadband operator. The token is supplied to the end-user. The CE equipment to cooperate with the modem in operational use is provided with a reader and data processor for reading the token's information, e.g., in a wireless fashion, and for configuring the modem apparatus accordingly. The invention provides the following advantages. There is no manual configuring needed of the modem and broadband connection. A PC is not required to configure the modem and broadband connection. This may open up business models for broadband CE devices. Further, the automatic configuration can be carried out instantly, as soon as the user has connected the equipment. Moreover, this system will decrease the need for after-sales service and thus decrease costs for the broadband provider. In addition, having the CE equipment accommodating the token reader will facilitate the user to associate the services and downloads directly with the relevant CE equipment.

More specifically, the invention relates to a CE data processing system configurable to communicate via a particular one of multiple data network environments. The system comprises a receiver for receiving configuration data from a physical token for configuring the system. For example, the system has a network interface such as a modem, a router or a dongle, and an appliance for data network communication via the network interface. The appliance accommodates the receiver for receiving the configuration data for configuration of the network interface. In an embodiment of the invention, the appliance accommodates the network interface, e.g., being built-in. Preferably, the token and the receiver are operative to communicate the configuration data in a wireless or contactless manner, using, e.g., radio-frequency (RF) or infra-red (IR) communication. Alternatively, the system and token communicate in a wired manner requiring physical, e.g., electric contact between the two.

Another embodiment of the invention relates to a CE appliance for data communication with a data network via a network interface, e.g., a modem or a router or a dongle. The appliance comprises a receiver for receiving configuration data from a physical token for configuring the network interface. Preferably, the reader is designed to communicate with the token in wireless fashion using, e.g., RF or IR.

Yet another embodiment relates to a method of enabling to configure a network interface for enabling consumer electronics data processing system to operate with a specific one of multiple network environments via the interface. The method comprises providing a token with information representative of data for configuring the interface via the system. Preferably, the system and the token communicate in a wireless fashion. The network interface comprises at least one of, e.g., a modem, a router, a dongle.

Still another embodiment relates to a physical token comprising information representative of data for configuring a network interface for a consumer electronics system to operate with a specific one of multiple network environments via the network interface. The token comprises a communicator for communicating with the system, preferably in a wireless fashion such as using RF or IR, or otherwise in a wired manner. If the token communicates in a wireless fashion with the CE appliance, physical ports for this communication can be omitted from the appliance's casing, thus contributing to a smooth, uncluttered design. An example of such a wireless token is based on the contactless smart-card technology of Royal Philips Electronics. A token used for identification purposes within such technology is commonly referred to as an RFID (RF identifier) tag.

The invention thus provides a simple and user-friendly manner to configure network equipment, i.e., equipment for use on a data network.

### BRIEF DESCRIPTION OF THE DRAWING

The invention is explained in further detail, by way of example and with reference to the accompanying drawing wherein:

FIG. 1 is a block diagram of a system in the invention;

FIG. 2 is a flow diagram of a method in the invention;

FIG. 3 is a block diagram giving details of components in the system of FIG. 1; and

FIG. 4 is a block diagram of another system in the invention.

Throughout the figures, same reference numerals indicate similar or corresponding features.

### DETAILED EMBODIMENTS

In order to obtain a connection to the Internet, a connection to the Internet Service Provider (ISP) has to be established first. For this, the user must know a number of parameters beforehand that are typically provided by the ISP using email or a CD-ROM by ordinary mail. The parameters are then used to configure a network interface such as a modem. Usually, the parameters are manually programmed into the interface with the use of a computer. Alternatively, the parameters could be programmed into the computer, which is connected to the interface, if the modem does not have the capability to store these parameters. For example, the following parameters or configuration information need to be known for establishing a connection: a login/username; a password; a DHCP (Dynamic Host Configuration Protocol) client activation. In some cases one also has to know: a primary DNS (Dynamic Name Server) IP address; a secondary DNS (Dynamic Name Server) IP address; a default gateway; and protocol parameters. The inventor proposes a system for automatically configuring the interface in a secure and user-friendly manner, and without the need of a personal computer.

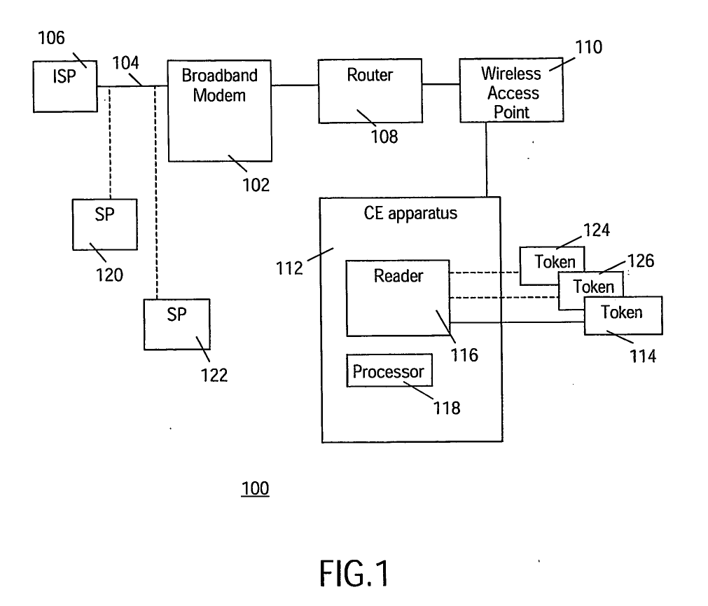

FIG. 1 is a block diagram of a system 100 in the invention. System 100 comprises a broadband modem 102 (or a broadband modem functionality 102 as, e.g., in a software implementation) to be configured for communication via a broadband connection 104 to an ISP 106 in order to get access to, e.g., the Internet. Modem 102 is equipped with the necessary hardware and software for establishing and terminating connection 104 to ISP 106. Connection 104 typically comprises a DSL or cable connection, but other media are possible such as Ethernet or satellite. Optionally, system 100 comprises a router 108. and a wireless access point (WAP) 110. Modem (DSL, cable, etc.) and router functionalities are known in the art and are not further discussed here. Modem 102, router 108 and WAP 110 serve to enable apparatus 112 to receive, or receive and transmit, data via, here, the Internet. Apparatus 112 comprises, e.g., a PC, a set-top box or another CE apparatus with a UI for rendering data received via connection 104.

Modem 102 is configured as follows. ISP 106 or another party supplies a token 114 to the end-user of system 100. Token 114 stores data for configuring modem 102. Apparatus 112 has a compatible reader 116, or can be connected to one, so as to be able to offload the data from token 114 to apparatus 112. Apparatus 112 typically has a data processor 118 that processes the data obtained from token 114 for configuring modem 102 so as to have it operating with the network environment provided by ISP 106.

Other service providers 120 and 122 may provide tokens 124 and 126, respectively, for configuring modem 102 according to their network and protocol specifications.

Token 114 may interact with reader 116 in a wired manner or in a wireless fashion using, e.g., RF. In the latter case, token 114 is, e.g., passive and gets powered through an RF signal from reader 116 to transmit the required data.

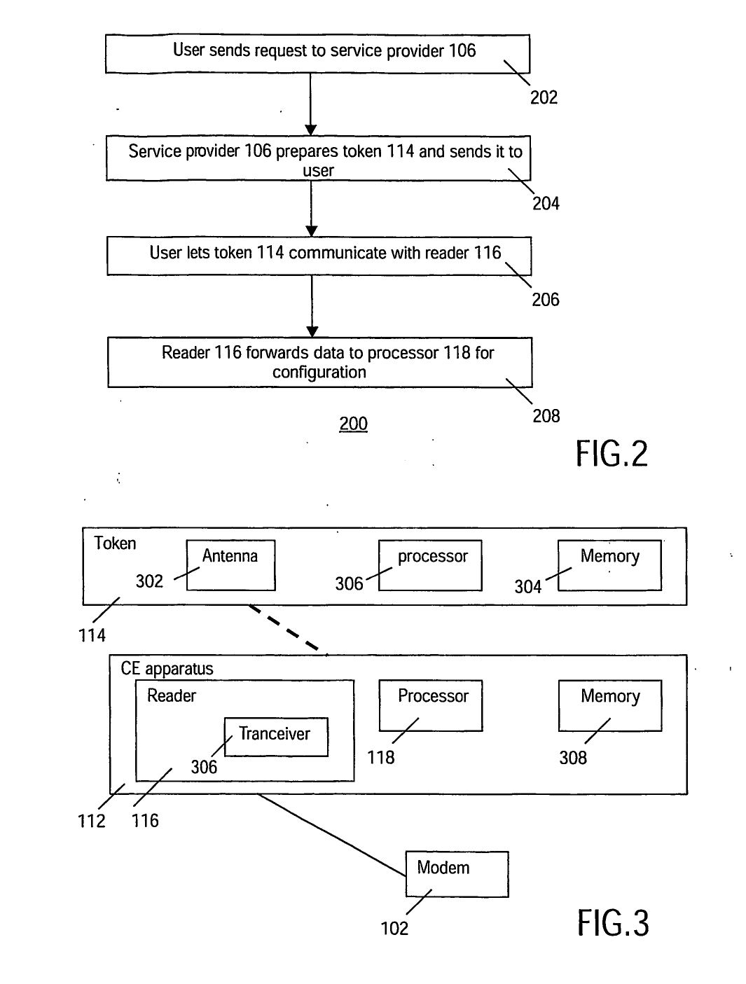

FIG. 2 is a diagram of a method 200 of the invention. In a step 202 the user of system 100 submits a request to service provider 106 for subscribing to the service provided. In a step 204, service provider 106 prepares token 114 and sends that to the user. In a step 206, the user having received token 114 lets it communicate with reader 116. In a step 208, reader 116 retrieves the configuration data from token 114 and forwards the data to processor 118 for configuring modem 102.

FIG. 3 is a block diagram of token 114 and apparatus 112 to illustrate a part of the configuration process using RF communication. Examples of RF technologies for wireless communication between apparatus 112 and token 114 are NFC (Near-Field Communication, a technology jointly developed by Royal Philips Electronics and Sony), Bluetooth, and HomeRF. NFC is a low-cost peer-to-peer (P2P) connectivity technology based on RF ID that enables automatic set up of secure PAN/LAN connections. It uses short-wave radio technology, and has a transfer speed of up to 212 kb/s, making it a viable alternative to Bluetooth.

For example, the RF communication between token 114 and apparatus 112 is based on short-range contactless smart-card technology as used by Royal Philips Electronics. See, e.g., the Data Sheet of “Mifare® Standard Card IC MF1 IC S50 Functional Specification May 2001”. For other aspects of contactless smart-card technology see, e.g., U.S. Pat. No. 5,345,231 (attorney docket PHO 90,508), incorporated herein by reference. Token 114 comprises a memory 302, e.g., a non-volatile solid-state memory, with configuration data. Token 114 further comprises a transmitter 304 for RF data transmission. Apparatus 102 accommodates reader 116 with a transceiver 306, processor 118, and a memory 308. Operation is as follows. Preferably, the user activates reader 116, e.g., by sliding or otherwise activating a switch (not shown). This temporary activation under user control avoids that reader 116 is active all the time. An antenna 302 in token 114 picks up the electromagnetic field emitted by reader 116 and thus powers the onboard circuitry of token 114 inductively. Token 114 then initiates a dialog using a predetermined protocol in order to start the exchange of data stored in a memory 304, under control of a processor 306. Memory 304 and processor 306 are powered by the electromagnetic field picked up by antenna 302. The data exchange may use an authentication step to ensure secure data transmission. Reader 116 interprets the data received from token 114. The data may comprise executable code. For example, the data comprises a java applet that is downloaded from token 114 to apparatus 112 to effect the configuration. Under control of processor 118, either programmed in advance to carry out the configuration of modem 102 or processing the java applet, the configuration data is written to a memory 308. From there, configuration of modem 102 can use any conventional process. Processor 118 communicates the configuration data or settings to modem 102, and the latter takes over these settings.

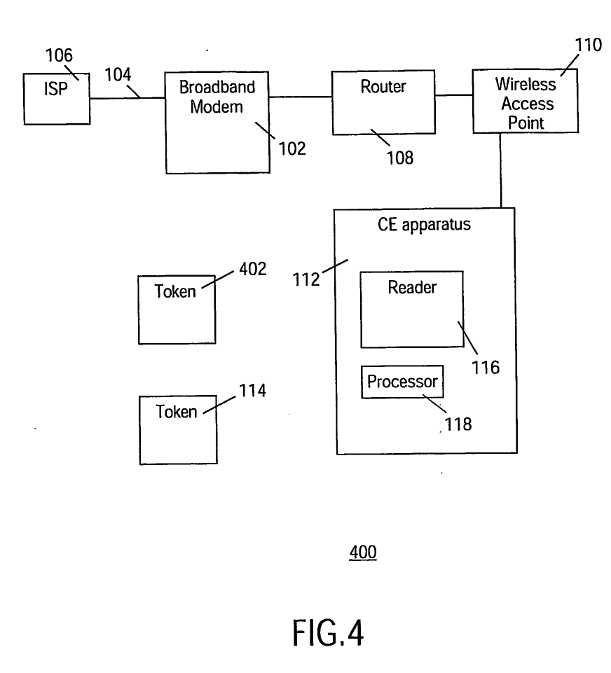

FIG. 4 is a block diagram of a system 400 in the invention. In this case, apparatus 112 is an Internet-enabled apparatus that itself needs specific settings to work with the network environment. Examples of an Internet-enabled apparatus are the Streamium MCi-200 and Streamium MX-i6000, both manufactured and marketed by Philips. Now, in order to configure apparatus 112, reader 116 can be used with a token 402 carrying configuration data for apparatus 112. Alternatively, token 114 carries configuration data for modem 102 and apparatus 112 (and possibly for further components on system 400) Now, if reader 116 is to be used with both token 114 and token 402, or with token 114 carrying configuration data for multiple components on system 400, system 400 has to determine which configuration data are to be used for what component. For this purpose, the configuration data includes one or more identifiers so as enable system 400 to determine the relevant component and to use the proper configuration data. For example, apparatus 112 queries modem 102 and other components for a number of anticipated responses to find the relevant specifics of modem 102 and the other components so as to be able to determine which configuration data goes with what component. As another example, system 400 is based on, e.g., UPnP, Jini, or another software architecture that enables querying an inventory of devices that have registered their capabilities with a Registry. For example, modem 102 has registered with the Registry and can accordingly be targeted with the appropriate configuration data.

1. A consumer electronics data processing system configurable to communicate via a particular one of multiple data network environments, the system comprising a receiver for receiving configuration data from a physical token for configuring the system.

2. The system of claim 1, having an appliance for data network communication via a network interface, the appliance accommodating the receiver for receiving the configuration data for configuring the network interface.

3. The system of claim 2, comprising the network interface.

4. The system of claim 3, wherein the appliance accommodates the network interface.

5. The system of claim 1, wherein the token and the receiver are operative to communicate the configuration data in a wireless manner.

6. The system of claim 2, wherein the network interface comprises at least one of: a modem, a router, a dongle.

7. The system of claim 6, wherein the interface comprises a broadband modem.

8. The system of claim 4, wherein the network interface comprises at least one of: a modem, a router, a dongle.

9. The system of claim 8, wherein the interface comprises a broadband modem.

10. The system of claim 1, having an appliance for data network communication, wherein the appliance is designed for being configured by means of at least a subset of the configuration data from the token.

11. The system of claim 10, wherein the appliance is operative to carry out the data network communication via a network interface, and the network interface is designed for being configured by means of another subset of the configuration data from the token.

12. A consumer electronics appliance for data communication with a data network via a network interface, the appliance comprising a receiver for receiving configuration data from a physical token for configuring the network interface.

13. The appliance of claim 11, wherein the token and the receiver are operative to communicate the configuration data in a wireless manner.

14. A method of enabling to configure a network interface for enabling consumer electronics data processing system to operate with a specific one of multiple network environments via the interface, the method comprising providing a token with information representative of data for configuring the interface via the system.

15. The method of claim 14, wherein the system and the token communicate in a wireless fashion.

16. The method of claim 15, wherein the network interface comprises at least one of: a modem, a router, a dongle.

17. The method of claim 16, wherein the interface comprises a broadband modem or a broadband modem functionality.

18. A physical token comprising information representative of data for configuring a network interface for a consumer electronics system to operate with a specific one of multiple network environments via the network interface, the token comprising a communicator for communicating with the system.

19. The token of claim 18 wherein the communicator communicates with the system in a wireless fashion.

20. The token of claim 18, wherein the network interface comprises a broadband modem or broadband modem functionality.

21. The token of claim 18, comprising further information representative of further data for configuring a consumer electronics appliance in the system.
